(19) United States
(12) Patent Application Publication
(10) Pub. No.: US 2006/0143143 A1
(43) Pub. Date: Jun. 29, 2006

(54) System and method for externalized inferencing components

(76) Inventors: Hoi Yeung Chan, Stamford, CT (US); Louis Ralph Degenaro, White Plains, NY (US); Isabelle M. Rouvellou, New York, NY (US)

Correspondence Address: F. CHAU & ASSOCIATES, LLC, 130 WOODBURY ROAD, WOODBURY, NY, 11797, US

(21) Appl. No.: 10/537,571

(22) PCT Filed: Dec. 21, 2002
(86) PCT No.: PCT/US02/41156

§ 371 Date: Jun. 3, 2005

(51) Int. Cl. G06N 5/02

(52) U.S. Cl. 706/47

(57) ABSTRACT

A technique is provided for managing (1210) externalizable inference components. The technique allows for dynamic construction of inferences from separate components, and externalization of data for controlling dynamic constructable inferences. One key benefit realized is the capability to mix and match various externalized inference components to form new inferences; or stated in a different way, the ability to deduce new knowledge by combining (reusing) and exercising various components in new ways. Provisions are made for pluggable inference components that can be combined in many distinct ways to fit the needs of different applications. This allows inference components to be developed independently and to be highly portable.

### BACKGROUND OF THE INVENTION

1. Technical Field

The present invention relates generally to software engineering, and more particularly, to techniques for employing externalizable inferencing components, including specifying, applying, and managing the same.

2. Description of Related Art

Various schemes have been developed for externalizing inferencing data. U.S. Pat. No. 5,136,523 by Landers, entitled “System for Automatically and Transparently Mapping Rules and Objects from a Stable Storage Database Management System Within a Forward Chaining or Backward Chaining Inference Cycle,” describes object and rule data being stored persistently in a database. In U.S. Pat. No. 5,446,885 by Moore et al., entitled “Event Driven Management Information System With Rule-Based Applications Structure Stored in a Relational Database”, again inferencing information is stored persistently. However, the prior art does not disclose the use of externizable inferencing components.

### SUMMARY OF THE INVENTION

According to an aspect of the invention, there is provided a method for managing a plurality of externalizable inferencing components. The method includes identifying inferencing aspects for a program, and then providing the identified inferencing aspects as inferencing components. Externalized algorithms and data (which may be stored persistently) can be associated with the inferencing components.

The identified inferencing aspects can include trigger points, short term facts, inference rules, inference engines, static variable mappings, sensors, effectors, long term facts, and conclusions. The inferencing components can include trigger point components, short term fact components, inference rule set components, inference engine components, static mapping components, sensor components, effector components, a long term fact components, and conclusion components.

The inferencing components may be a consumer of data provided by an inferencing component, a supplier of data provided by an inferencing component, or both.

The method can further include associating at least one trigger point inferencing component with at least one application. Trigger points may operate either synchronously or asynchronously.

The inferencing components may be master inferencing components that employ at least one other inferencing component. Inferencing components may use an inferencing engine. Further, inferencing components can be organized into at least one inferencing subcomponent. Inferencing components may also be shared by reference with at least one other inferencing component.

The organization/composition of inferencing components can be an array, a collection, a hashtable, an iterator, a list, a partition, a set, a stack, a tree, a vector, and a combination thereof.

The inferencing components can include an unique identifier, an intention, a name, a location, a folder, a start time, an end time, a priority, a classification, a reference, a description, a firing location, a firing parameter, an initialization parameter, an implementor, a ready flag, free form data, and a combination thereof.

The algorithms may perform inferencing component creation, inferencing component retrieval, inferencing component update, and inferencing component deletion. Further, the algorithms may be shared by at least two inferencing components.

The algorithm may be an execute trigger point algorithm, return data algorithm, a join data algorithm, a filter data algorithm, a translate data algorithm, a choose by classification algorithm, a choose randomly algorithm, a choose round robin algorithm, an inference engine pre-processor, an inference engine post-processor, an inference engine launcher, a receive data algorithm, a send data algorithm, a store data algorithm, a fetch data algorithm, and a combination thereof.

The inferencing components may be composed of at least two inferencing subcomponents that form a new inferencing entity. The composition occurs either statically or dynamically (or a combination thereof).

To facilitate creating, retrieving, updating, and deleting inferencing components, an inference component management facility may be employed.

According to another aspect of the invention, a system for providing business logic is provided. The system includes an identification component and an externalization component. The identification component is configured to identify at least one point of variability within an application program, and the externalization component is configured for providing the identified at least one point of variability with externalized business logic. The externalized business logic includes an inferencing component. The inferencing component can include an externalized algorithm and data.

The system may also include an execution component for executing the externalized algorithm using at least one virtual machine (e.g., JAVA Virtual Machine (JVM)).

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system 100 to which the present invention may be applied, according to an illustrative embodiment thereof;

FIG. 2 is a block diagram illustrating example applications with trigger points utilizing inference components, in accordance with a preferred embodiment of the present invention;

FIG. 3 is a block diagram illustrating inference components architecture, in accordance with a preferred embodiment of the present invention;

FIG. 4 is a block diagram illustrating example inference components interactions, in accordance with a preferred embodiment of the present invention;

FIG. 5 is a block diagram illustrating example inference rule set components interactions, in accordance with a preferred embodiment of the present invention;

FIG. 6 is a block diagram illustrating example inference static mapping components interactions, in accordance with a preferred embodiment of the present invention;

FIG. 7 is a block diagram illustrating example inference rule set components and static mapping components combinations, in accordance with a preferred embodiment of the present invention;

FIG. 8 is a block diagram illustrating example inference rule set components and dynamic mapping components (sensors and effectors) combinations, in accordance with a preferred embodiment of the present invention;

FIG. 9 is a block diagram illustrating example inference long term fact components interactions, in accordance with a preferred embodiment of the present invention;

FIG. 10 is a block diagram illustrating example inference short term fact components interactions, in accordance with a preferred embodiment of the present invention;

FIG. 11 is a block diagram illustrating example inference conclusion components interactions, in accordance with a preferred embodiment of the present invention; and

FIG. 12 is a block diagram illustrating example inference component management facility interactions, in accordance with a preferred embodiment of the present invention.

### DETAILED DESCRIPTION OF PREFERRED EMBODIMENTS

Externalization of business rules and externalization of trigger points are known techniques for orchestrating application behaviors. For example, “System and Method for Employing Externalized, Dynamically Configurable, Cacheable Trigger Points,” by Degenaro et al., U.S. patent application Ser. No. 09/956,644, filed on Sep. 20, 2001, which is incorporated by reference in its entirety, descibes a technique for employing a trigger point in a logic flow. The general idea is to replace logic normally embedded within applications by trigger points that in turn appeal to external authorities to perform the desired processing. The variability of applications so engineered can then be easily and dynamically manipulated without altering the rule-driven applications themselves. The placement of trigger points at various layers of an application enables corresponding levels of rules abstraction. Centralization of the externalizable logic and data advances the possibilities for understandability, consistency, reuse, and manageability while coincidentally reducing the maintenance costs of the sundry applications employing trigger points and rules across an enterprise.

In the context of externalization, “rules” are not those usually associated with the artificial intelligence community, but are rather ones used to make everyday “business” decisions. The technique employed is more structurally oriented than declarative, and the rules employed are often straightforward. In general, new knowledge is not sought after, but instead time and situational variability is easily managed.

For example, an airline's application may consider a frequent flier to be bronze, silver, or gold based upon the number of miles flown with them during one year. As time goes by and more miles are accumulated, one's status might change from bronze to silver, or from silver to gold. Further, the number of miles needed to be classified as bronze, silver, or gold might change over time from 10000, 20000, 30000 to 15000, 25000, 50000 respectively. Or a new classification of platinum may be added for those traveling at least 75000 miles in a calendar year.

Prior to externalization techniques, classifying a customer into a category might be coded in-line. But in using externalizable trigger points and rules, the logic and data for performing the classification would be external to the application proper. By externalizing both the algorithms that make such determinations and the data that parameterize them, increased manageability of behavioral variability can be attained.

Alternatively, reasoning systems often employ inferencing techniques, such as forward-chaining and backward-chaining, and Rete networks to derive new knowledge. Such systems are usually comprised of three main elements: knowledge, usually in the form of if/then rules and facts; working memory, consisting of derived facts; and an inference engine that processes the knowledge and working memory.

During forward-chaining, an inference engine examines the inference rules and facts determining which inference rules are eligible to be fired. One inference rule, chosen by using conflict resolution techniques, is fired. This may cause actions to occur or new facts to be generated. Iteration continues for inference rule selection and firing until no more inference rules are eligible. When completed, zero or more conclusions are reached.

During backward-chaining, an inference engine examines the facts and data to determine if a goal has been reached. Intermediate goals are added and removed until such time that the original goal can be proven true or false. Each goal is an inference rule that, when evaluated with the pertinent data, is proven true, is proven false, or refers to one or more other inference rules that must first be proven true or false.

The Rete algorithm is an optimized method of inferencing. A network of nodes is employed so as to assure that only new facts are tested against any inference rule.

Typically, reasoning or knowledge based systems can be used to learn new facts. For example, it might be learned that when people in China purchase a camera, they often also purchase a carrying case; whereas people in France may purchase batteries in addition to a camera.

These two different rules oriented programming models, externalization and reasoning, each have their strengths and weaknesses. Each can be applied to the same problem sets with one usually having an advantage over the other in key aspects depending on the situation. For example, reasoning may be more favorable when the rules employed are changing frequently, or when determining exactly how a result was obtained is not important, or when rule conflicts can be addressed at run-time, or when the number of rules involved is quite large, or when high performance is not required. Externalization may be more advantageous in the reverse situations, such as small rules set sizes, infrequent rule changes, when high performance is critical, and so forth.

One key problem is how to beneficially utilize both externalization and reasoning together in order to enjoy all their combined advantages while avoiding the drawbacks of each. At some places externalization techniques alone will meet requirements; at other places inferencing techniques alone will suffice; still at other points some combination of these two different but complementary approaches offers the best fit.

Another key problem is how to organize reasoning systems and their associated data. One can imagine that slightly different versions of inferencing may be desired by applications. For example, perhaps an inference rule set is universal in nature but some or all of its variables are mapped according to a context associated with a place in an application, or one of time. Or perhaps two different applications have portions of their desired inference rules sets in common. Or perhaps the conclusions of two or more different inferences need to be combined as input to yet one or more other inferences.

It is to be understood that the present invention may be implemented in various forms of hardware, software, firmware, special purpose processors, or a combination thereof. Preferably, the present invention is implemented in software, the software being an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device.

It is to be further understood that, because some of the constituent system components depicted in the accompanying Figures may be implemented in software, the actual connections between the system components may differ depending upon the manner in which the present invention is programmed. Given the teachings herein, one of ordinary skill in the related art will be able to contemplate these and similar implementations or configurations of the present invention.

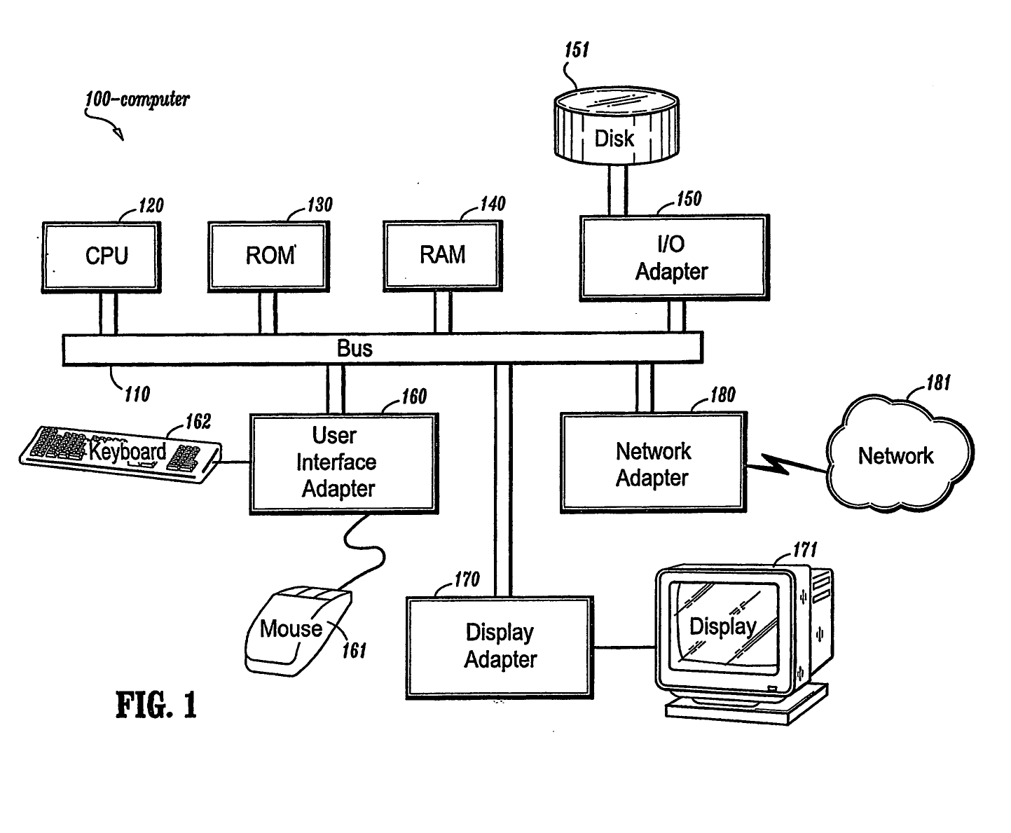

FIG. 1 is a block diagram of a computer processing system 100 to which the present invention may be applied, according to an illustrative embodiment thereof. The computer processing system 100 includes at least one processor (CPU) 120 operatively coupled to other components via a system bus 110. A read only memory (ROM) 130, a random access memory (RAM) 140, an I/O adapter 150, a user interface adapter 160, a display adapter 170, and a network adapter 180 are operatively coupled to the system bus 110.

A disk storage device (e.g., a magnetic or optical disk storage device) 151 is operatively coupled to the system bus 110 by the I/O adapter 150.

A mouse 161 and keyboard 162 are operatively coupled to the system bus 110 by the user interface adapter 160. The mouse 161 and keyboard 162 may be used to input/output information to/from the computer processing system 100.

A display device 171 is operatively coupled to the system bus 110 by the display adapter 170. A network 181 is operatively coupled to the system bus 100 by the network interface adapter 180.

While the computer processing system 100 has been described herein with reference to the above elements, it is to be appreciated that additions, deletions, and substitutions of elements may be made with respect thereto. That is, given the teachings of the present invention provided herein, one of ordinary skill in the related art will contemplate this and various other configurations of the elements of computer processing system 100, while maintaining the spirit and scope of the present invention.

The present invention provides a method and system for specifying, applying, and managing externalizable inference components in a data processing application. Among other things, the present invention addresses the key problems of how to beneficially utilize both externalization and reasoning together in order to enjoy all their combined advantages while avoiding the drawbacks of each; and how to organize reasoning systems and their associated data.

The present invention allows for placement of trigger points within applications that employ externalizable inference components (EICs). Typically, applications will pass context and parameter information to trigger points, which then dynamically identify and employ EICs. Typically, EICs consider input, perform inferencing related tasks accordingly, and return results to trigger points. Alternatively, a trigger point may operate asynchronously, whereby an application invokes a trigger point providing context and parameter input, receiving in return a key which can be used to check for results at some later time; or an application may additionally provide to a trigger point a key for a thread that is to receive control with any results once the asynchronous inference process completes.

Although all externalizable data and algorithms can be contained within a single EIC, often an EIC is comprised of a main component which has associated with it one or more other EICs. Typically, a main component orchestrates the desired inference. It gathers and pre-processes facts and rules, maps variables, triggers an inference engine, and post-processes and distributes any results. Subcomponents handle specialized tasks, such as provision of a rule set to be utilized by an inference engine; mapping of variables to static values or variable functions; filtering of conclusions to be returned to an application; and so forth.

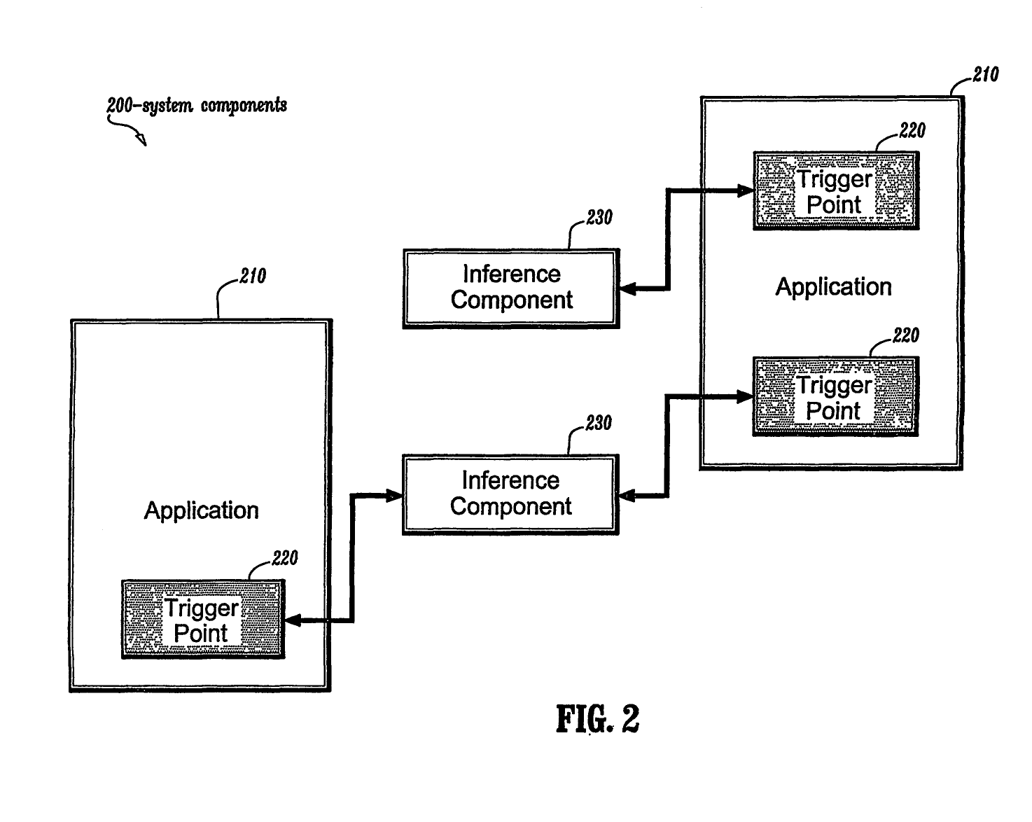

FIG. 2 is a diagram illustrating system components where example applications 210 contain trigger points 220 that utilize externalizable inference components 230, in accordance with a preferred embodiment of the present invention. During run time, applications 210 supply context and parameter information to trigger points 220 which in turn employ EICs 230. The EICs 230 perform some inferencing calculation and return results to the trigger points 220 which propagate the results to applications 210. For example, an application 210 may supply a context of “calculate discount” and a parameter of “shopping cart” to a trigger point 220, which then utilizes an appropriate EIC 230 to make a discount inferencing calculation with the given shopping cart information, which is returned to the trigger point 220 for consideration by the application 210.

One skilled in the related art can contemplate many combinations of trigger points 220 and EICs 230. For example., a single application 210 may employ several trigger points 220; a single trigger point 220 may utilize several EICs 230; multiple applications 210 may share use of one or more trigger points 220; and multiple trigger points 220 may share use of one or more EICs 230.

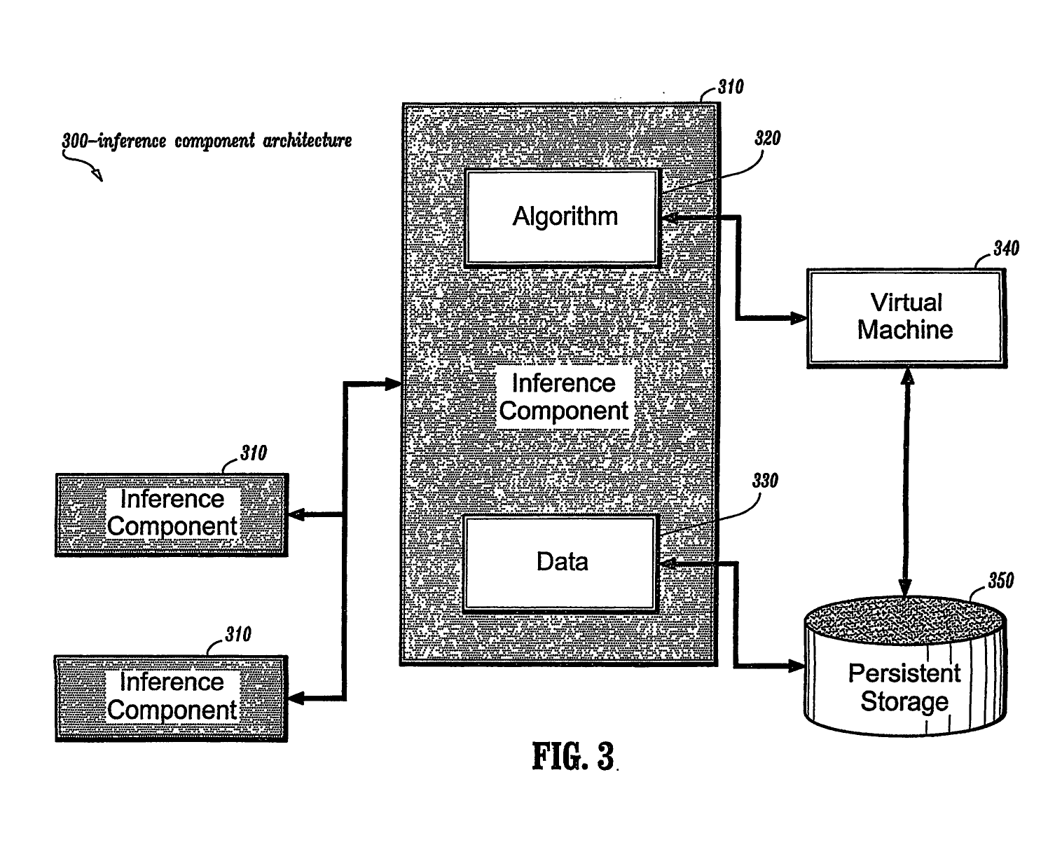

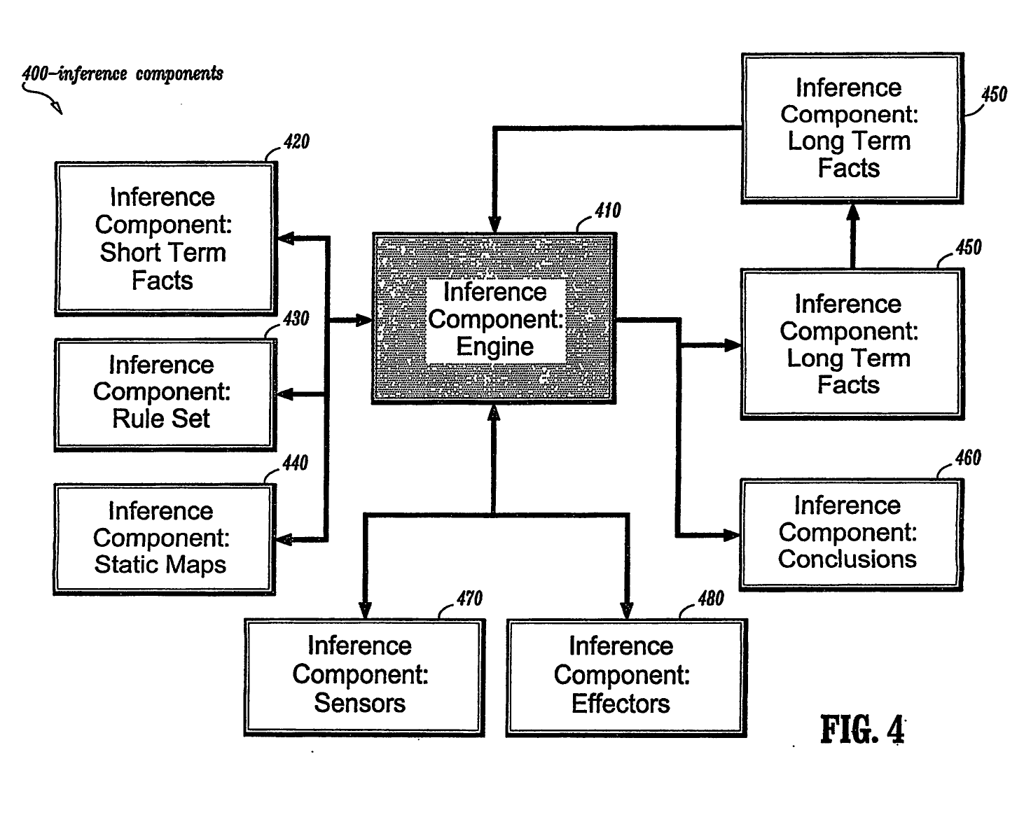

FIG. 3 is a diagram illustrating example externalizable inference component architecture in accordance with a preferred embodiment of the present invention. EICs 310 may act alone (not shown) or in conjunction with other EICs that perform separable tasks. In the latter case, a master EIC is usually employed by a trigger point to coordinate the activities of one or more servant EICs. This aspect is discussed with respect to FIG. 4 below. Each EIC 310 is comprised of an algorithm 320 and data 330. The data 330 is persistently maintained on a storage device 350. The algorithm is executed by a virtual machine 340. The virtual machine 340 may load the algorithm 320 from persistent storage 350.

For example, an EIC algorithm 320 may be a Rete inference engine processed by a Java Virtual Machine (JVM), and data 330 may be a set of rules to be interpreted by the Rete inference engine in the presence of parameters passed by a trigger point to perform a “calculate discount” inference. Having the algorithm 320 and data 330 externalized offers the advantages of flexibility, understandability, and manageability, among others. A key advantage is that changes to data 330 or algorithms 320 are external to applications desiring inferencing services, thus buffering applications from such changes. Continuing the above example, a new rule may be added to a set of rules comprising the data 330 to be interpreted by the algorithm 320; in addition (or instead) a forward-chaining inference engine may be substituted for a Rete inference engine as the algorithm 320. Under a wide variety of circumstances, related applications changes would be unnecessary thus promoting application stability.

A master EIC 310 may employ other EICs 310 to perform specific tasks, such as data aggregation, data propagation, data translation, parallel logic calculations, and so forth. Key externalizable inference components are described in greater detail below. During run time, data and/or control may flow between EICs bi-directionally. An EIC may employ zero or more other EICs.

EICs may employ re-usable algorithms to: execute trigger point, return data, join data, filter data, translate data, choose by classification, choose randomly, choose round robin, choose by date, inference engine pre-processor, inference engine post-processor, inference engine launcher, receive data, send data, store data, fetch data, and others.

EICs may employ externalized data comprising: an unique identifier, an intention, a name, a location, a folder, a start time, an end time, a schedule, a period, a duration, a priority, a classification, a reference, a description, a firing location, firing parameters, initialization parameters, an implementor, a ready flag, free form data, and others. For example, an implementor might be a forward chaining inference engine and the initialization parameters might be a set of rules to be interpreted.

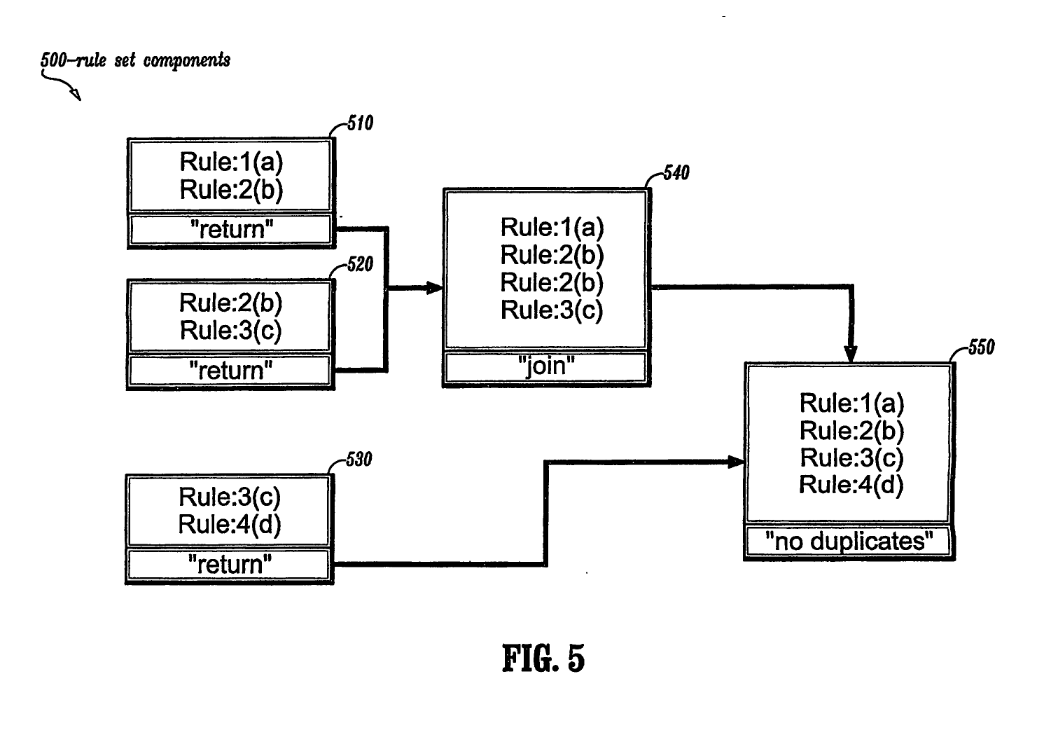

FIG. 4 is a diagram illustrating example externalizable inference components in accordance with a preferred embodiment of the present invention. The externalizable inference component engine 410 can be a master component that employs other externalizable inference components to perform specific tasks. Alternatively, a master component can perform all tasks unassisted by other EICs (not shown). Key servant EICs often employed by an EIC engine 410 are: short term facts 420, rules set 430, static maps 440, long term facts 450, conclusions 460, sensors 470, and effectors 480. Each of these are described in more detail below, with respect to FIGS. 5-11. A servant EIC may act unassisted or may itself be a master component that employs servant EICs. A master component may employ zero or more types of servant EICs and may employ zero or more of each type of EIC.

EICs may be organized or composed in various ways. For example a master EIC may be composed of one or more servant EICs as an array; a collection; a hashtable; an iterator; a partition; a set; a stack; a tree; a vector; and others; or as some combination of representations. The organization is according to a design for the combination of the algorithm and associated data.

More concretely, a master EIC may be composed of a vector of long term facts components together with an array of short term fact components, a tree of rule set components, and a conclusion component.

The main task of an EIC engine 410 is to perform inferencing on facts and rules to derive new facts. A key advantage of the EIC paradigm is that facts and rules have been externalized and componentized in a regularized way, which greatly facilitates reuse and sharing. For example, a rule set used to “calculate discount” can be used by multiple EIC engines 410 even though mapping from input data to rule set variables may be different in some cases. Or multiple EIC engines 410 can utilize the same rule set but produce different conclusions. Or multiple EIC engines 410 can utilize different rule sets but the same mapping from input data onto rule set variables. One skilled in the related art can envision myriad possibilities for constructing EIC engines 410 sharing other EICs 400.

The EIC engine 410, like all EICs, is comprised of data and algorithm constituent parts, as described above with respect to FIG. 3. The algorithm performs pre-inferencing activities, invokes the inference engine, then performs post-inferencing activities. The pre- and post-inferencing activities are in accordance with the associated externalized data and algorithm. In the case of a solitary EIC engine 410 having no servant EICs, data needed by the inference engine is gathered by the pre-inferencing phase from either the supplied input, or the associated EIC engine data, or some derivative thereof; data produced by the inference engine is potentially subject to a post-inferencing phase for a variety of purposes, such as recording newly derived facts, effecting other processes, and so forth.

Typically, an EIC engine will employ other EICs to perform specific tasks. For example, as part of the pre-inferencing phase, an EIC engine 410 might employ an EIC short term facts 420 to verify and filter supplied input data that will be consumed by its inference engine; it might employ an EIC rule set 430 to obtain the rules to be consumed by its inference engine; it might employ an EIC static maps 440 to map facts onto rules variables for inference engine consumption; it might employ EIC sensors 470 and effectors 480 to map fact getters and setters onto rules variables for inference engine consumption; it might employ an EIC long term facts 450 to gather facts previously derived for inference engine consumption; and so forth. As part of the post-inferencing phase, an EIC engine 410 might employ an EIC long term facts 450 to record facts newly produced by its inference engine; it might employ an EIC conclusions 460 to filter, recast, or embellish inference engine produced facts to be returned to the requesting application; and so forth.

An interesting aspect of inference components 400 is that they can examine, update, create, and delete each other. For example, the purpose of a particular EIC engine 410 might be to update an EIC rule set 430 by adding, deleting, or changing data (inference rules), thus effecting operation of EIC engines 410 employing a revised EIC rule set 430. One skilled in the related art can imagine many combinations of inference component relationships.

FIG. 5 is a diagram illustrating example externalizable rule set inference components in accordance with a preferred embodiment of the present invention. Rule Set Component (RSC) 510 has two inference rules, “Rule:1” and “Rule:2”, each of which act on a single variable, “a” and “b” respectively. The algorithm for RSC 510 is “return”. When requested upon RSC 510 will provide its two inference rules in response. RSCs 510, 520, and 530 all employ the same algorithm, and all (coincidentally) have two inference rules as data. Note that in this example, RSC 520 has one inference rule in common with RSC 510, “Rule:2”, and one inference rule in common with RSC 530, “Rule:3”.

RSC 540 has a “join” algorithm. Its data is not the 4 inference rules shown, but rather references to RSCs 510 and 520. When called upon, the algorithm of RSC 540 requests the inference rules from RSC 510 and RSC 520 to formulate its own set of inference rules. A join algorithm simply accumulates data provided by RSCs it references without regard to content. In this example, that results in RSC 540 having “Rule:1” and “Rule:3” each appear once and “Rule:2” appear twice in its inference rule set.

RSC 550 has a “no duplicates” algorithm. Its data is not the 4 inference rules shown, but rather references to RSCs 530 and 540. When called upon, the algorithm of RSC 540 requests the inference rules from RSCs 530 and 540 to formulate its own set of inference rules. A no duplicates algorithm simply accumulates data provided by RSCs it references and removes duplicates. In this example, that results in RSC 550 having one each of “Rule:1”, “Rule:2”, “Rule:3”, and “Rule:4”. Notice that “Rule:2” was provided twice by RSC 540, but appears only once in the inference rules set of RSC 550. Similarly, “Rule:3” was provided to RSC 550 twice, once from each of RSC 530 and RSC 540, but it also only appears once in the resultant inference rule set.

The rule set components paradigm is key to managing large rules sets by enabling them to be partitioned into smaller, manageable, reusable pieces. One skilled in the related art can imagine a plethora of useful combinations of inference rule sets as data, and associated algorithms that act upon the inference rule set data directly or by reference, ultimately consumed by an inference engine.

Note that inference rules are typically statements of the form “if condition is ‘condition x’ then result is ‘result x’”. “Rule:1(a)” represents “if condition is ‘condition a’ then result is ‘result a’”. Similarly, “Rule:2(b)” represents “if condition is ‘condition b’ then result is ‘result b’”.

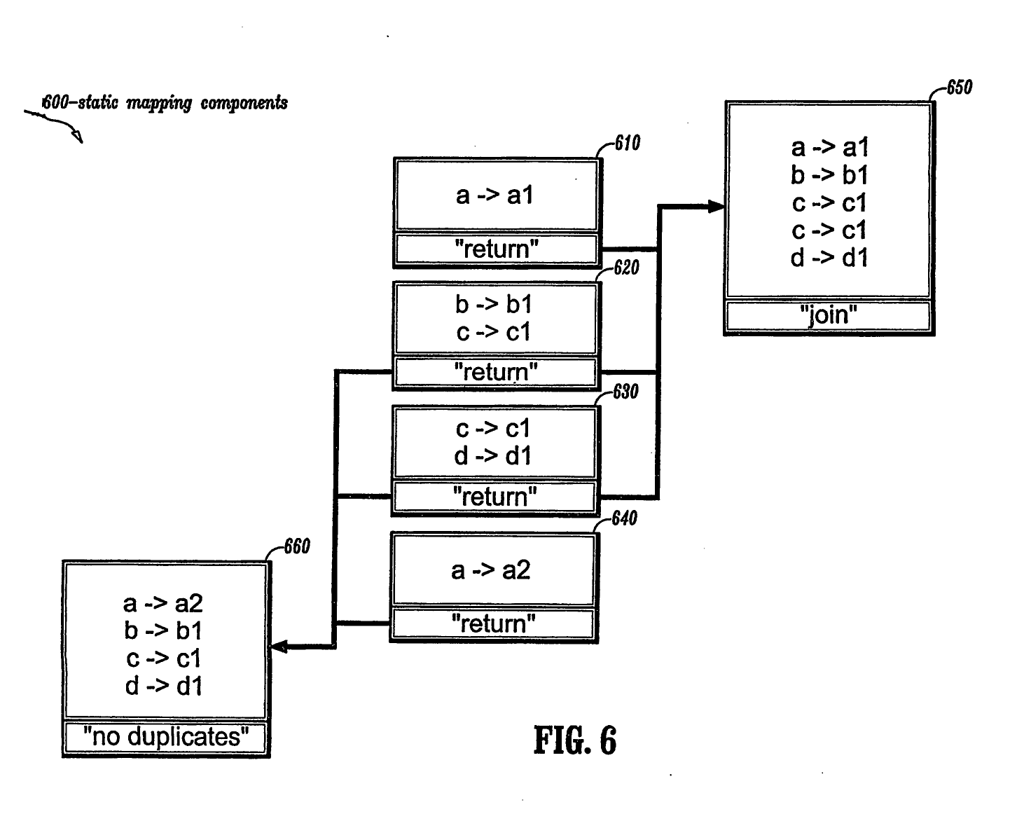

FIG. 6 is a diagram illustrating example externalizable static mapping inference components in accordance with a preferred embodiment of the present invention. Static Mapping Components (SMCs) 610 and 640 each have one mapping as data, “a->a1” and “a->a2” respectively. SMC 620 has two mappings as data, “b->b1” and “c->c1”. SMC 630 has two mappings as data, “c->c1” and “d->d1”. SMCs 610, 620, 630, and 640 all share the same algorithm, “return”. When each is called upon, SMCs 610-640 will simply return the mapping data contained.

SMC 650 has a “join” algorithm. Its data is not the 5 static mappings shown, but rather references to SMCs 610, 620, and 630. When called upon, the algorithm of SMC 650 requests the static mappings from the SMCs upon which it references, 610, 620, and 630, to formulate its own set of static mappings. In this example, that results in SMC 650 having “a->a1”, “b->b1”, and “d->d1” each appear once and “c->c1” appear twice in its static mappings.

SMC 660 has a “no duplicates” algorithm. Its data is not the 4 static mappings shown, but rather references to SMCs 620, 630, and 640. When called upon, the algorithm of SMC 660 requests the static mappings from SMCs 620-640 to formulate its own set of static mappings. In this example, that results in SMC 660 having one each of “a->a2”, “b->b1”, “c->c1”, and “d->d1”. Notice that “c->c1” was provided to SMC 660 twice, once from each of SMC 620 and SMC 630, but it also only appears once in the resultant static mappings set of SMC 660.

The algorithms enjoyed by rules set components can be shared with static mapping components and/or any other components and vice-versa. Code and data reuse is a key advantage of the present invention. Thus, in the examples presented in FIGS. 5 and 6, the algorithm “return” is common to both RSCs and SMCs, as are the “join” and “no duplicates” algorithms.

The static mappings components paradigm is key to managing large mapping sets by enabling them to be partitioned into smaller, manageable, reusable pieces. One skilled in the related art can imagine a plethora of useful combinations of static mappings as data, and associated algorithms that act upon the static mappings data directly or by reference, ultimately consumed by an inference engine.

Note that inference static mappings are typically statements of the form “substitute ‘value’ for ‘variable’”. The mapping “a->a1” represents “substitute ‘value a1’for ‘variable a’”. Similarly, mapping “a->a2” represents “substitute ‘value a2’ for ‘ariable a’”.

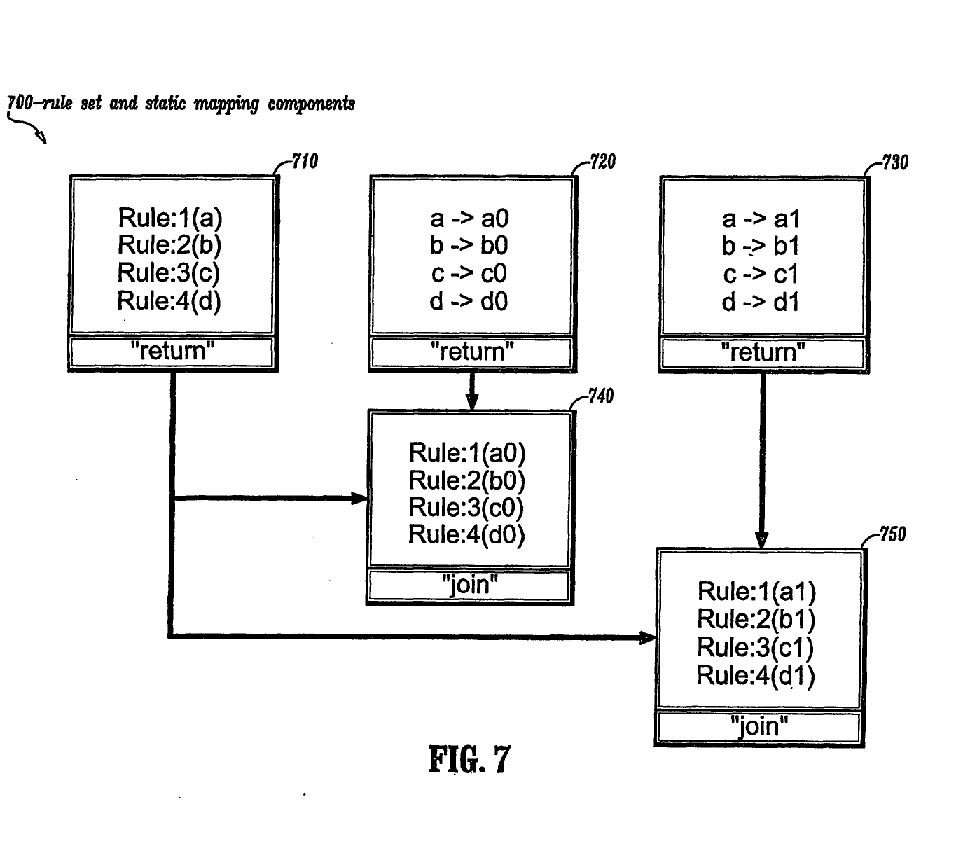

FIG. 7 is a diagram illustrating example externalizable rule set and static mapping inference components in accordance with a preferred embodiment of the present invention. Two different types of supplier EICs are shown, RSC 710 and SMCs 720, 730. Two composed EICs 740, 750 are comprised of combinations of supplier RSC and SMCs. This example shows a key advantage of the present invention where components are utilized together to compose new entities usable by an inference engine. EIC 740 is a combination of a rule set and a static mapping. EIC 750 is a combination of the same rule set with a different static mapping. Each demonstrates another key advantage of the present invention: component reuse. In this example, the algorithms associated with the supplier components are simply “return”, and the algorithms associated with the composed components are simply “join”.

A master EIC engine (e.g., 410 of FIG. 4) might employ a servant EIC, such as EIC 750, as a reference that produces Rules 1-4 having variables a-d substituted as a1-d1 respectively upon demand. Presume EIC 710 is altered to contain a new Rules having variables “a” and “c”. With this change a master EIC engine would then receive Rules 1-5 with variables a-d substituted as a1-d1 when employing EIC 750. Notice the key advantage of component composition demonstrated by this example of the present invention. Both EIC 740 and 750 would contain the added Rule5 because both are consumers of EIC 710. EIC 730 remains unchanged, yet still contributes to the resulting EIC 750.

A composition, such as EIC 740, can occur statically (prior to runtime) or dynamically (at runtime). “Rule:3(c0)” represents “if condition is ‘condition c0’ then result is ‘result c0’”. Similarly, “Rule:4(d1)” represents “if condition is ‘condition d1’ then result is ‘result d1’”.

More concretely, “Rule:3(c)” might represent “if customer status ‘c’ then give customer discount ‘c’”; “c->c0” might represent “substitute ‘condition: bronze, result: 10 percent’ for ‘c’”; the combination results in: if customer has status ‘bronze’ then give customer discount ‘10 percent’.

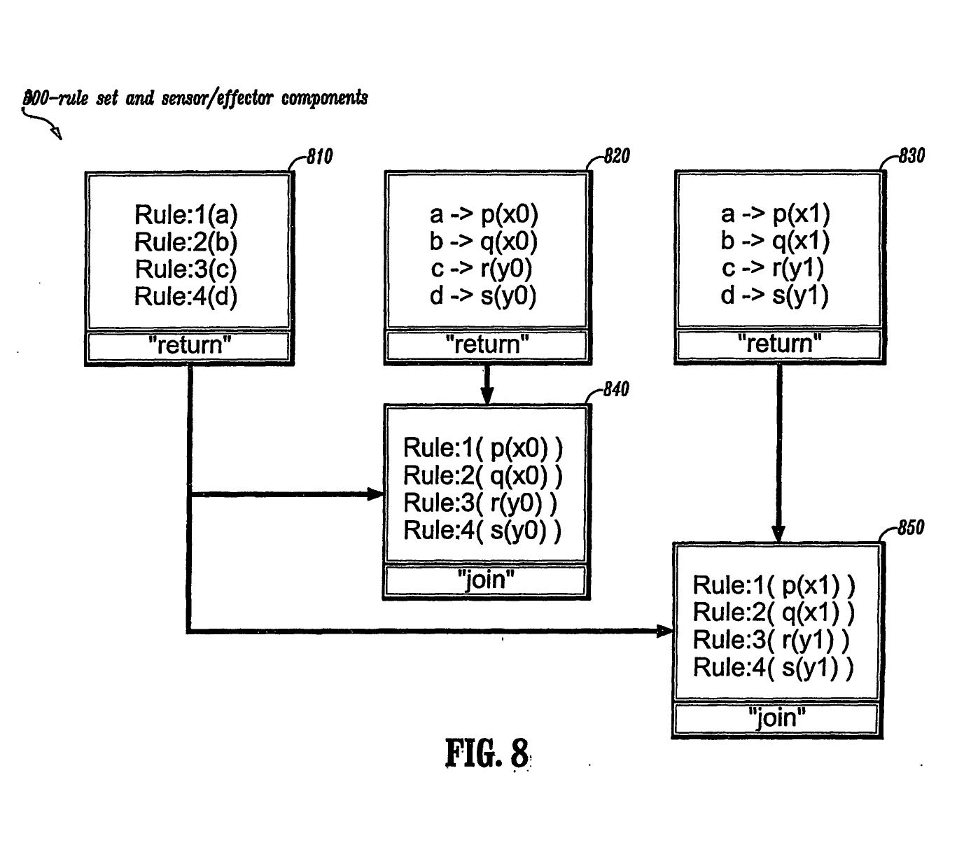

FIG. 8 is a diagram illustrating example externalizable rule set and dynamic (sensor and effector) mapping inference components (DMCs) in accordance with a preferred embodiment of the present invention. Two different types of supplier EICs are shown, RSC 810 and DMCs 820, 830. Two composed EICs 840, 850 are comprised of combinations of supplier RSC and DMCs. This example shows a key advantage of the present invention where components are utilized together to compose new entities usable by an inference engine. EIC 840 is a combination of a rule set and a dynamic mapping. EIC 850 is a combination of the same rule set with a different dynamic mapping. Each demonstrates another key advantage of the present invention: component reuse. In this example, the algorithms associated with the supplier components are simply “return”, and the algorithms associated with the composed components are simply “join”.

A master EIC engine (e.g., 410 of FIG. 4) might employ a servant EIC, such as EIC 840, as a reference that produces Rules 1-4 having variables a-d substituted as functions p(x0), q(x0), r(y0), and s(y0) respectively upon demand. Presume EIC 820 is altered to change the dynamic mapping of “d” to “t(y3)”. With this change a master EIC engine would then receive Rules 1-4 with variables a-d substituted as functions p(x0), q(x0), r(y0), and t(y3) when employing EIC 840. Notice the key advantage of component composition demonstrated by this example of the present invention. Only EIC 840 would contain the changed Rule4 because only it is a consumer of EIC 820. EIC 810 remains unchanged, yet still contributes to the resulting EIC 840.

A composition, such as EIC 840, can occur statically (prior to runtime) or dynamically (at runtime). “Rule:1(p(x0))” represents “if condition is ‘condition function p(x0)’ then result is ‘result x0’”. Similarly, “Rule:2(q(x0))” represents “if condition is ‘condition function q(x0)’ then result is ‘result x0’”.

More concretely, “Rule:3(c)” might represent “if customer status ‘c’ then give customer discount ‘c’”; “c->r(y0)” might represent “substitute ‘condition: bronze, result: lookupPercentage(bronze)’ for ‘c’”; the combination results in: if customer has status ‘bronze’ then give customer discount ‘looked-up percentage for bronze’.

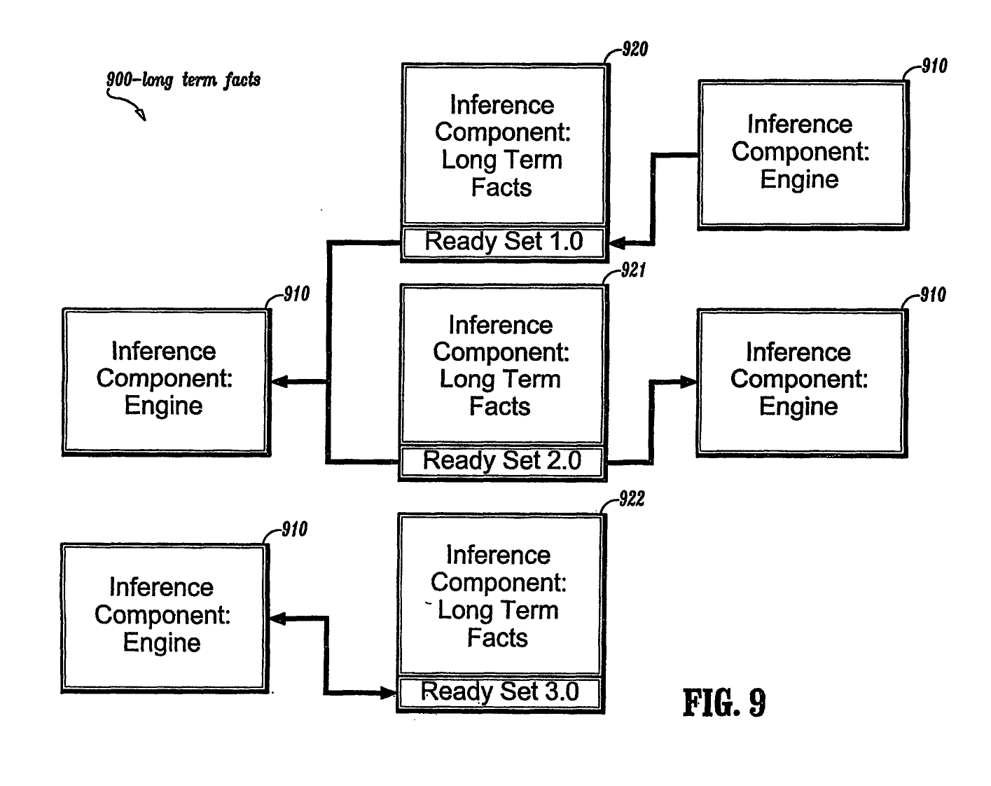

FIG. 9 is a diagram illustrating example externalizable long term facts inference components (LFCs) in accordance with a preferred embodiment of the present invention. Two different types of EICs are shown, EIC engines 910 and LFCs 920, 921, and 922. The LFCs employ an algorithm that operate in two modes, receive/store and fetch/send. For example, LFC 921 receives data from an EIC engine 910 and stores it persistently as Ready Set 1.0; it also fetches Ready Set 1.0 from persistent storage and supplies an EIC engine with the data. LFC data receiving and sending can operate in push or pull fashion (as can all EICs). This example shows a key advantage of the present invention where components are utilized to partition data into maintainable pieces usable by an inference engine.

Multiple LFCs can supply a single EIC. Multiple EICs can supply a single LFC (not shown). An LFC in particular (or any EIC in general) can receive from only, send to only, or both receive from and send to one or many EICs. One skilled in the related art can imagine many combinations of LFCs and EICs with respect to receiving/storing and fetching/sending persistent data.

Anecdotally, Ready Sets 1.0, 2.0, and 3.0 may be long term facts about gold, silver, and bronze status customers respectively.

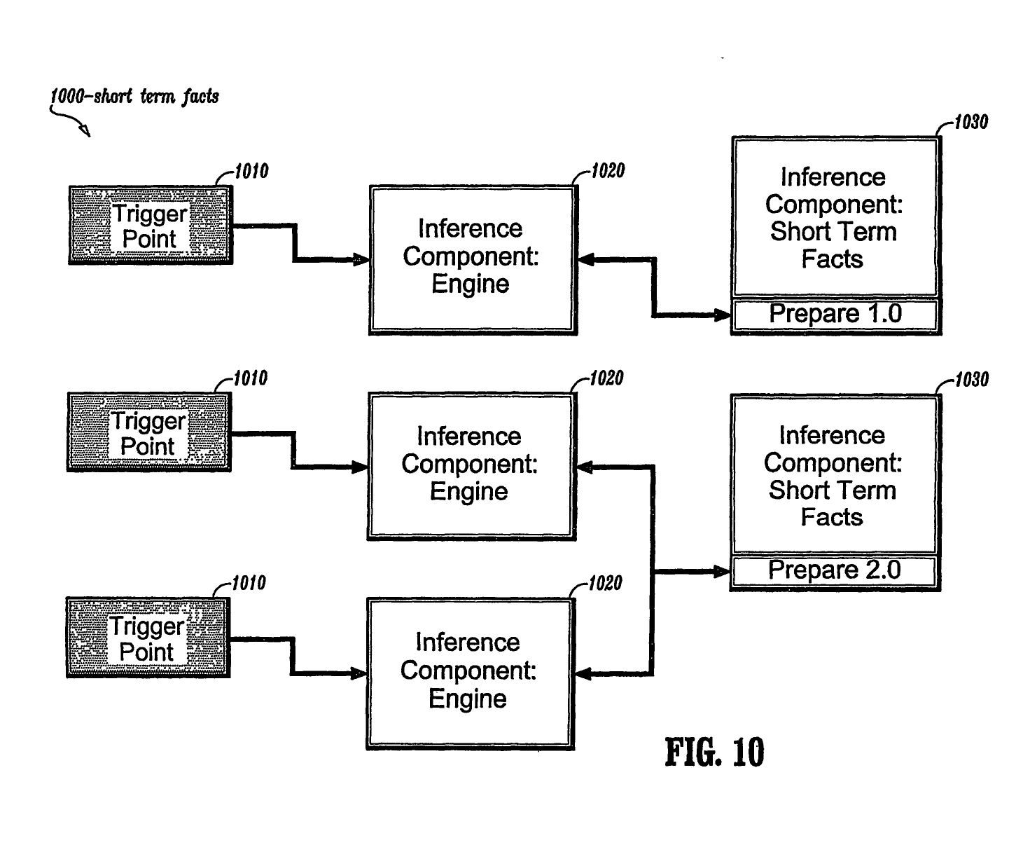

FIG. 10 is a diagram illustrating example externalizable short term facts inference components (SFCs) in accordance with a preferred embodiment of the present invention. Trigger points 1010 and two other different types of EICs, EIC engines 1020 and SFCs 1030, are shown. Typically, trigger points 1010 supply data to EIC engines 1020 at runtime. Typically, EIC engines 1020 employ one or more SFCs 1030 to transform data supplied by trigger points into short term facts for consumption by inference engines. Like other EICs, the SFCs employ an externalized algorithm parameterized by externalized data. Usually in the case of SFCs, the purpose of the algorithm is to consume trigger point supplied data and make transformations to inference engine consumable data. Typically, in contrast to LFCs, SFCs do not keep short term facts themselves persistently. Transformation algorithms as well as transformation data may be common or different amongst SFCs.

Anecdotally, Prepare 1.0 and 2.0 may be data sets, such as “shopping carts”, supplied by trigger points within applications transformed by SFCs 1030 into short term facts, such as “purchase list”, consumable by inference engines.

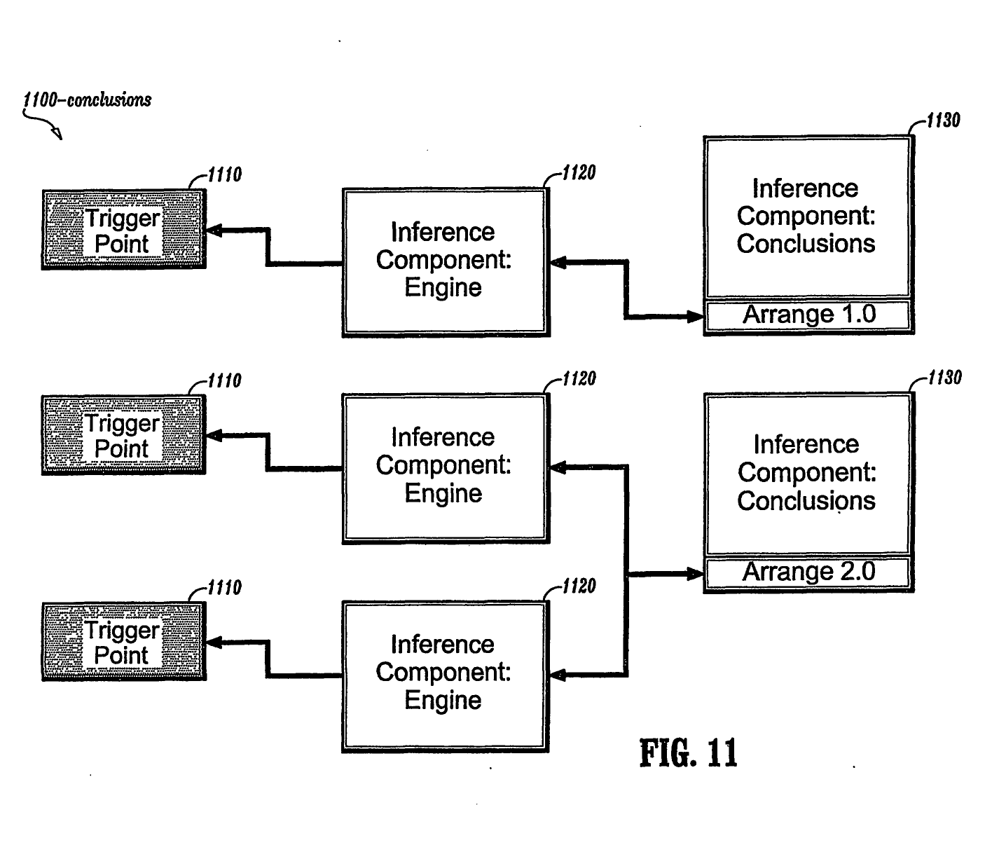

FIG. 11 is a diagram illustrating example externalizable conclusion inference components (CCs) in accordance with a preferred embodiment of the present invention. Trigger points 1110 and two other different types of EICs, EIC engines 1120 and CCs 1130, are shown. Typically, trigger points 1110 consume results from EIC engines 1120 at runtime. Typically, EIC engines 1120 employ one or more CCs 1130 to transform results determined by inference engines into data for consumption by trigger points. Like other EICs, the CCs employ an externalized algorithm parameterized by externalized data. Usually in the case of SFCs, the purpose of the algorithm is to consume trigger point supplied data and make transformations to inference engine consumable data. Typically, in contrast to LFCs, CCs do not keep conclusions themselves persistently. Transformation algorithms as well as transformation data may be common or different amongst CCs.

Anecdotally, Arrange 1.0 and 2.0 may be data sets, such as “discount results”, consumed by trigger points within applications, transformed by CCs 1130 from short term facts, rules, long term facts, and other EIC available resources processed by inference engines.

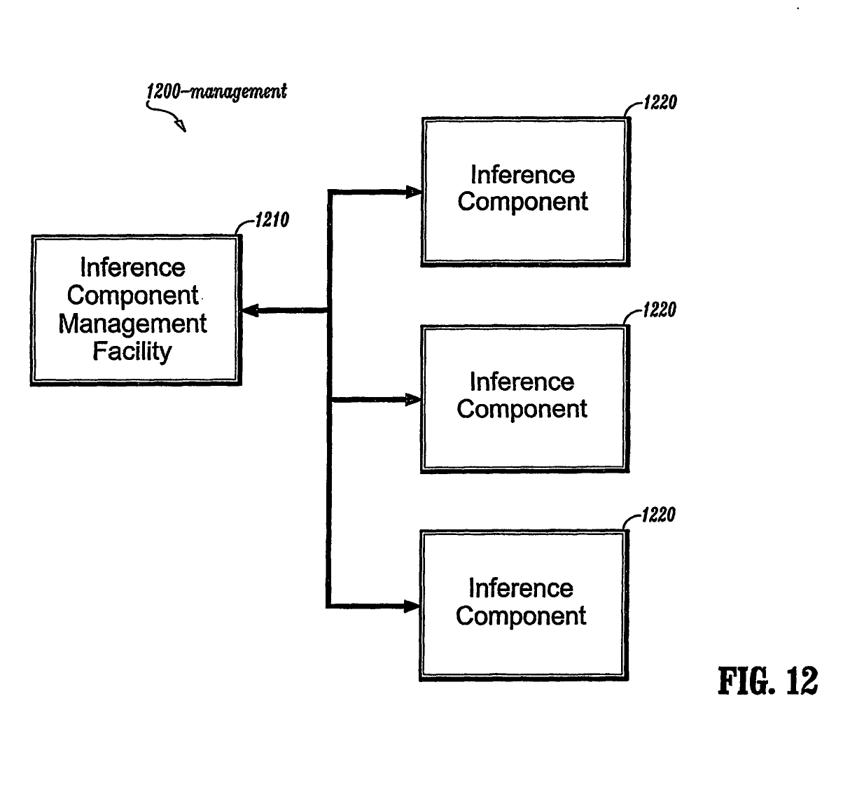

FIG. 12 is a diagram illustrating example inference component management facility (ICMF) interactions in accordance with a preferred embodiment of the present invention. An ICMF 1210 and three EICs 1220 are shown. The ICMF is used to create, retrieve, update, and delete EICs through an application program interface (API). For example, using the API a new EIC engine component can be created; or an existing LFC component can be deleted; or an existing RSC component can be retrieved to discover its contents; or an existing RSC can be modified to contain more rules; and so forth.

Although the illustrative embodiments have been described herein with reference to the accompanying drawings, it is to be understood that the present system and method is not limited to those precise embodiments, and that various other changes and modifications may be affected therein by one skilled in the art without departing from the scope or spirit of the invention. All such changes and modifications are intended to be included within the scope of the invention as defined by the appended claims.

What is Claimed is:

1. A method for deploying computer infrastructure, comprising integrating computer-readable code into a computing system, wherein the code in combination with the computing system is capable of performing:
identifying inferencing aspects for a program; and
providing the identified inferencing aspects as inferencing components, wherein the inferencing components are externalizable.

2. The method of claim 1, wherein the providing step includes associating an externalized algorithm and data with each of the inferencing components.

3. The method of claim 2, wherein the data is stored in persistent memory.

4. The method of claim 1, wherein the identified inferencing aspects include at least one of a trigger point, a short term fact, an inference rule, an inference engine, a static variable mapping, a sensor, an effector, a long term fact, and a conclusion.

5. The method of claim 1, wherein the inferencing components include at least one of a trigger point component, a short term fact component, an inference rule set component, an inference engine component, a static mapping component, a sensor component, an effector component, a long term fact component, and a conclusion component.

6. The method of claim 2, wherein each of the inferencing components is one of a consumer of data provided by an inferencing component, a supplier of data provided by an inferencing component, and a combination thereof.

7. The method of claim 1, further comprising the step of associating at least one trigger point inferencing component with at least one application.

8. The method of claim 4, wherein trigger points operate either synchronously or asynchronously.

9. The method of claim 1, wherein at least one of the inferencing components is a master inferencing component that employs at least one other inferencing component.

10. The method of claim 1, wherein at least one of the inferencing components employs an inferencing engine.

11. The method of claim 1, wherein at least one of the inferencing components is organized into at least one inferencing subcomponent.

12. The method of claim 11, wherein the organization is one of an array, a collection, a hashtable, an iterator, a list, a partition, a set, a stack, a tree, a vector, and a combination thereof.

13. The method of claim 1, wherein at least one of the inferencing components is composed of at least one inferencing subcomponent.

14. The method of claim 13, wherein the composition is one of an array, a collection, a hashtable, an iterator, a list, a partition, a set, a stack, a tree, a vector, and a combination thereof.

15. The method of claim 2, wherein each of the inferencing components has at least one of an unique identifier, an intention, a name, a location, a folder, a start time, an end time, a priority, a classification, a reference, a description, a firing location, a firing parameter, and initialization parameter, an implementor, a ready flag, and free form data.

16. The method of claim 1, wherein at least one of the inferencing components is shared by reference with at least one other inferencing component.

17. The method of claim 2, wherein at least one of the algorithms perform at least one of inferencing component creation, inferencing component retrieval, inferencing component update, and inferencing component deletion.

18. The method of claim 2, wherein at least one of the algorithms is shared by a plurality of inferencing components.

19. The method of 2, wherein each of the algorithms is one of an execute trigger point algorithm, a return data algorithm, a join data algorithm, a filter data algorithm, a translate data algorithm, a choose by classification algorithm, a choose randomly algorithm, a choose round robin algorithm, an inference engine pre-processor, and inference engine post-processor, an inference engine launcher, a receive data algorithm, a send data algorithm, a store data algorithm, and a fetch data algorithm.

20. The method of claim 1, wherein the providing step uses an inference component management facility to administer inferencing components, the administration including operations to create, retrieve, update, and delete.

21. The method of claim 1, wherein at least one of the inferencing components is composed of a plurality of inferencing subcomponents.

22. The method of claim 21, wherein the composition occurs one of statically, dynamically, and a combination thereof.

23. The method of claim 21, wherein the composition occurs using an inference component management facility.

24. A system for providing externalized business logic, comprising:
an identification component configured to identify at least one point of variability within an application program; and
an externalization component for providing the identified at least one point of variability with externalized business logic, the externalized business logic including an inferencing component.

25. The system of claim 24, wherein the inferencing component includes an externalized algorithm and data.

26. The system of claim 25, further including a persistent memory component configured to persistently store the data.

27. The system of claim 24, further including an execution component for executing the externalized algorithm using at least one virtual machine.

28. The system of claim 24, wherein the inferencing component is composed of a plurality of inferencing subcomponents.

29. The system of claim 28, wherein the composition occurs dynamically.

30. The system of claim 28, wherein the composition occurs statically.

31. The system of claim 28, wherein the composition occurs in part dynamically and the remainder statically.

32. The system of claim 24, wherein the identified at least one point of variability includes at least one of a trigger point, a short term fact, an inference rule, an inference engine, a static variable mapping, a sensor, an effector, a long term fact, and a conclusion.

33. A program storage device readable by a machine, tangibly embodying a program of instructions executable on the machine to perform method steps for managing a plurality of inferencing components, the method steps comprising:
identifying inferencing aspects for a program; and
providing the identified inferencing aspects as inferencing components, wherein the inferencing components are externalizable.
